(19) United States
(12) Patent Application Publication
(10) Pub. No.: US 2009/0070124 A1
(43) Pub. Date: Mar. 12, 2009

(54) Method

(76) Inventor: Kent G. Anderson, Bismarck, ND (US)

Correspondence Address: KENT G ANDERSON;FUTURE SM/TM, 925 N GRIFFIN, BISMARCK, ND, 58501, US

(21) Appl. No.: 11/880,086

(22) Filed: Jul. 20, 2007

(51) Int. Cl. G06Q 99/00

(52) U.S. Cl. 705/1; 705/500

(57) ABSTRACT

The method of and process of building businesses and doing business creations, etc. and the development of any and all ideas, goods and services that can be thought of and created by the human mind and can serve a purpose can be protected under the identify or name such as, for example, Future. Then market these in all marketing sectors, so forth, in building new products and services under the name Future and not limited to the name Future.

With these identities infrastructures will be built and interconnect with other infrastructures which deals with any and all products and services, especially new goods, products and services that can be discovered. These can be built around that identity, so on and so forth, for testing, manufacturing, promoting, marketing in all marketing sectors with the intent to develop new products and services, so on and so forth by providing a place to test and market by any and all means. The brand name Future and not limited to Future will identify unique products, services, markets and industries focusing on intellectual property ideas and will launch new products, services, and new industries by franchising the name with other entities and interconnecting all products, services, etc. to create large infrastructures where people can test and market their ideas.

### BACKGROUND OF THE INVENTION

The present invention is to relate to the process of doing business and a method of building infrastructures, Future brands, etc. and on-line infrastructures to market and to test ideas online in any marketplace with related protecting rights there of. The invention will identify any new markets built around any new products, services, etc. with testing promoting, marketing in any and all marketing sectors and markets. Identified markets will be built around those marketing sectors.

The main scope of the invention is a method, etc. of doing business in addition to stores and businesses that sell similar products. The difference is the design and the marketing and promoting of the same goods, as well as, a different name. There needs to be an open market to bring in new goods and products, etc. with especially future related goods and products, thus making Future original in doing business with any business in any marketing sector.

Future deals with marketing any marketable products or good especially in building new markets for products and services from the ideas people have and those ideas that have not even been discovered or developed yet. With these new ideas, Future will be bringing in new products and infrastructure in business in any marketing sector thereof which includes products, goods, services and trade from innovative ideas of any person that encompasses an oral language, writing, touch or feel, written word and anything that can be protected related to and will be identified and marketed through a vast arena of interconnected infrastructures—anything of now and anything which deals with the future.

This is a complex intellectual property with rights and licenses in promoting and building of new infrastructures with new products and services by interconnecting infrastructures and by building infrastructures of Future brands, etc. Identified will be any markets which deals with the new and not the old and where people can test ideas. Also identified will be the markets for launching new ideas, products and services in any marketing sector set forth identified with new ideas, products and patents and with markets which build new company's products and services around those goods, products and services by identifying new classifications and new patent rights, etc. to launch new ideas, products and services in any marketing sector set forth.

Included will be a project dealing with futuristic designs which also will encompass a place where people can test their ideas in any marketing sector. This place will encompass future themes for retail stores, hotels and motels. This place similar to a city is identified with the name Future which represents the research and industries dealing with any new product and/or service etc. Featured would be Future TV broadcasting, museums, theaters, retail stores, industries, research centers, manufacturing and others. Again this is a place where people can test ideas in any marketing sector and meet business leaders who would test and place ideas into marketing into any marketing sector.

The business means and methods with identifying intellectual property rights will be the securing of the rights to the name of Future and to identify future rights to the name, etc. and the identifying of future products, industries and markets as new intellectual property under the brand Future. Included will be the building of entities and the identification of Future with the new ideas, products and services. All people will have a chance to bring in new ideas, products and services and to invest in these innovations. For people who want to be affiliated with the brands and the name or names which identifies Future, the name rights, intellectual property rights and methods will be secured which allow people to test these ideas including on-line for production and marketing in any marketing sector.

With the building of those markets, etc. in the name of Future around those sectors with new products and services, building themes in the marketplaces and infrastructure will be futuristic in design. Products and services of any industry may be included in a futuristic designed like city where goods, services and industries can be launched and branched out to any marketing sector with the building of infrastructures around the new products with Future brands and names. Included would be retail stores, entertainment sector, transportation services, industrial services, health care services, financial services, etc. especially relating to and the creating of new services and goods and products under the Future name or names. The intent is to build those sectors and markets and new markets under the name of Future, to invest in people and their ideas in any marketing sector and to build those sectors that are new or not in existence at this time. This includes any company or industry that deals with goods/products and services thought of in the future. It includes the thought or thoughts that could be created into a service or product, the design means for the products and the services and marketing with the ability to build a large infrastructure around those new ideas and markets and so forth. The intent is to discover new products and intellectual property and to build markets around those, such as, one of many examples is to provide the interconnecting of networks worldwide in order to read stories live via on-line to call upon those readers anywhere at any time to promote reading. Testing and marketing of people's ideas, providing and building of new infrastructures and the interconnecting with other infrastructures would include internet and news media services.

### SUMMARY OF THE INVENTION

This invention relates to process methods, etc. of building and securing all intellectual property rights identified with Future trademark/trademarks rights and intellectual rights, etc. which deals with now and of the future, especially the future goods, products and services and intellectual properties. Protection of intellectual property rights to products, services, etc. of now and of the future will be secured with the rights to the name Future and by building industries and markets under the name Future. Also to be protected is the business method of testing products in any marketing sectors including on-line services. This would include any ideas and products in any and all fields and markets and the on-line services, where ideas and products would be tested electronically. This invention is a method of doing business by testing, producing, marketing, advertising, building markets and infrastructures and interconnecting markets and infrastructures so forth.

For example, by interconnecting live story readers live via Internet called upon by clients world wide, stories read live in any language can be accessed through a web site which identifies and calls on specific readers. The invention of the method will include many examples and creations with infrastructures online and in the real world to test and to market anything by any and all means or methods of creating new ideas.

The method of protecting intellectual property is by having any means in which to identify any goods and services, for example by applying on-line web page. Goods and services listed will be identified with the name or names not limited to Future sm./tm. Usage will be shown with claiming rights and licensing under intellectual property rights.

The following will help further explain the invention and the business methods; as follows, to build a place futuristic in designs and themes which encompasses any industry and services, so forth and a place to launch new products and services with industries. Everything will be related to the future with a place like a futuristic city that encompasses research centers, industry and commerce, etc. especially focusing on and representing new goods or products that haven't been thought of or produced.

An object of the invention is the method of building a unique infrastructure in which to identify new products, process methods, intellectual properties and to launch new products and services under the Future name. Also markets will be identified and infrastructures built online to interconnect and allow ideas and products to be tested in any marketing sector. Online interconnection of networks will provide any means to test people's ideas and intellectual properties by any and all means and to build markets to license intellectual properties.

Another object of the invention is the methods process of creating and securing legal rights to the use of the name Future with methods, intellectual properties and in any marketing sector new products, new services, license, etc. for those goods and services that are created from new ideas, products and intellectual properties that are discovered and tested. Included will be the licensing of the new products, goods, and services and the building of distribution channels around those new markets, infrastructures, networks online, so forth.

Another object of the invention is to build an infrastructure with infrastructures within for the different properties and intellectual properties, to create unique markets and infrastructures with new franchises, rights, licenses and to build industries with products, goods and services.

Another object of the invention is the method of creating ideas for products for now and the future and of incorporating these ideas.

Another object of the invention is the method of protecting the name Future and to apply the name to those good and services that sow usage with established legal rights, and to apply for that name for licensing of intellectual property.

Another object is the applying for licensing of intellectual property or properties under the name chosen especially Future. Licensing rights are currently available under the name Future.

### DETAILED DESCRIPTION OF THE INVENTION

### Example 1

Process method is to build infrastructures by any and all means within a huge entity, to identify rights, products and services that are new, and to build those infrastructures, methods, markets and products so forth around those entities thereof.

### Example 2

Process method is to build and protect the name of Future and not limited to the name of Future; the rights to identify products and services methods by the name, etc. and to build new industries and markets under the name Future, etc.; to build these infrastructures around those entities and to provide an area to test people's ideas in any marketing sector; to protect those rights dealing with any intellectual rights, so on; to build infrastructures online and in the real world identifying new products and services and to build and interconnect those infrastructures and markets, etc. by any and all means.

### Example 3

Process method is to create Future, etc. entities in which to develop products and intellectual properties and to market those new products and services in any marketing sector by any and all methods interconnecting markets and infrastructures in any and all structures and markets, so forth.

### Example 4

Process method is to build an infrastructure, a place, to identify many different entities services, goods and products, etc., a place to test all ideas in any marking sector and a place to meet business leaders, etc. Every detail of the futuristic structure, manufacturing, commerce, etc. is futuristic in style. The city encompasses research centers, museum, theaters, retail stores, radio and TV broadcasting center, so on. This includes any identifying services in any and all classes and fields classified as such and any and all products, goods and services that can be created and thought of now and for the future. Any services of Future can be in a superstructure. Every detail and related products will be futuristic and future related. This would include new entertainment launching new promotions, new industrial promotion of goods and the promoting and launching of a product, goods and services in any marketing sector. This is a place that will also have its own financial services with a Future bank that does not look at a person's assets but identifies them with their dreams and ideas. It is a place to meet financial partners and leaders. In addition it is a place where to focus on the benefit for all people's needs and a place where we can work together for the benefit of all humankind.

### Example 5

process method is any means to create new jobs Online with new opportunities. By connecting networks and online services, new methods, new products and services will be created by the Future name, etc. Included will be the building of channels for licensing, new infrastructures and new markets.

### Example 6

process method is the securing the rights under the name Future, and not limited to the name Future to include any marketing sector and to build new means, new products, new services, infrastructures and places and on-line, to provide a place where people can test ideas in any marketing sector by any and all means and to launch new products under the Future name, etc. Included are securing rights to unique markets around new products' names, intellectual property, products, methods and interconnecting infrastructures and so forth.

### Example 7

process method is a method of creating in languages, writing, art, taste, touch, feel and any means by which one can communicate ideas or inventions, etc. New products and so on that can be created by the mind and invented for the human being and their surroundings, that have a use and can be used, created and sold can be identified by the name Future, etc. By protecting intellectual property rights, markets and infrastructures can be built around new intellectual property, so forth any process method thereof interconnecting networks.

### Example 8

process method is the building of new markets from ideas, products and services and interconnect marketing by building vast infrastructures which include methods, markets and distributorships etc. which deal with any marketing sector, any produceable goods, anything that can be created, marketed and sold. These goods, products and services means can be identified by the name Future not limited to the name Future, etc. in a new means, intellectual property and rights. Also many names can be attached onto the name Future thus providing more rights and ways in creating new products and services by creating those markets and by opening structures around those ideas and sectors, so forth.

### Example 9

method process is creating a huge Future means city with the Future theme and which is self-contained and operated by the occupants who have the goals and values to carry on to other generations of leaders and who care for all people for the benefit of our world.

### Example 10

the method process is to create a means to allow people to test their ideas etc. by any electronic, by any and all means on-line etc., and to interconnect other networks. Future will build a new world tm to create new products and services, etc. and to build marketing channels, distributorships and infrastructures, etc. working with other entities and licensing, etc. for the benefit for all.

### Example 11

process method is the method of securing legal rights and of showing usage of names by identifying every good, service and marketing sector with the name with protection by sm., for example Future sm. retail services, so on. Then usage can be shown on-line with the ability to apply for intellectual property licensing, so on and so forth.

### BRIEF DESCRIPTION OF DRAWINGS

The structure is designed to carry out the function of the invention method will hereinafter be described together with the feature thereof. The invention will be more readily understood from reading the summary and detailed embodiments of the invention and by reference to the accompanying drawing forming a part thereof within an example of the invention is shown.

FUTURE has an infrastructure similar to a country with FUTURE BRANDS used by people to realize their innovative ideas into products and services. FUTURE is like a living cell that replicates itself through people's own ideas for FUTURE.

### Flow Diagram

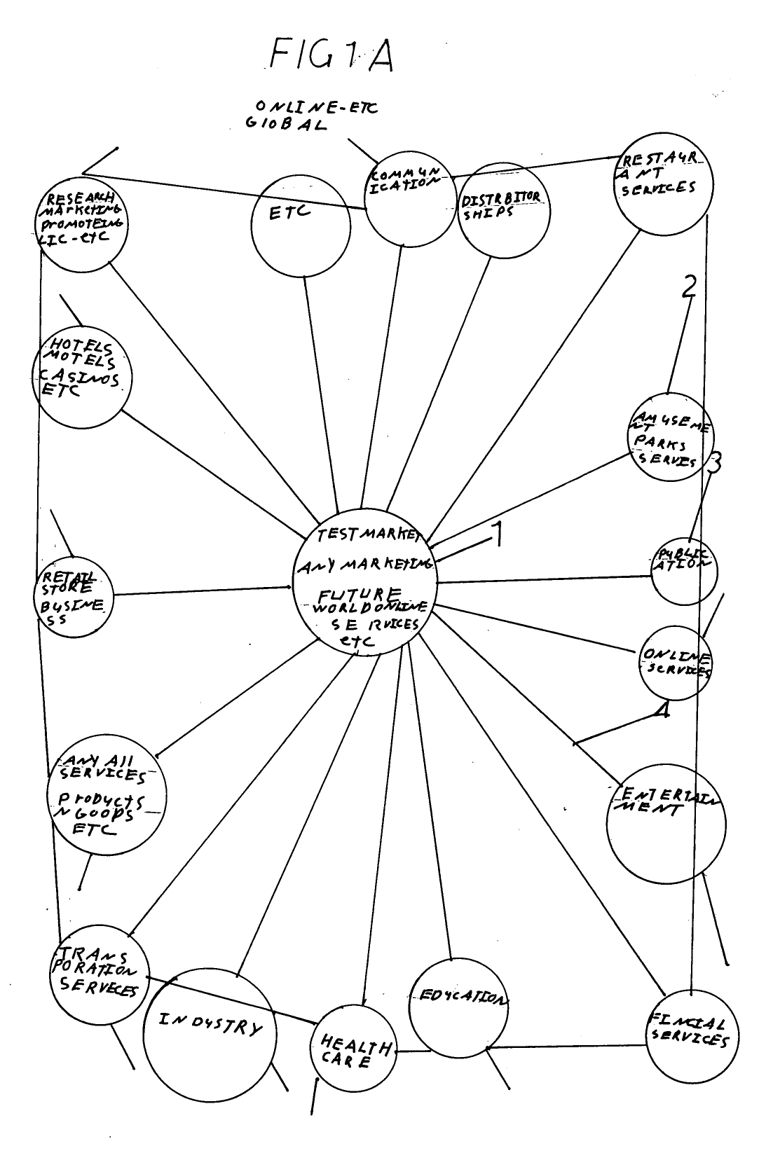

Seen in FIG. 1A is a top view

No. 1 shows the FUTURE cell the heart of the intellectual property showing how FUTURE is born through innovative goods and services thus creating new goods and new services. The FUTURE cells shows the services and ideas of the people.

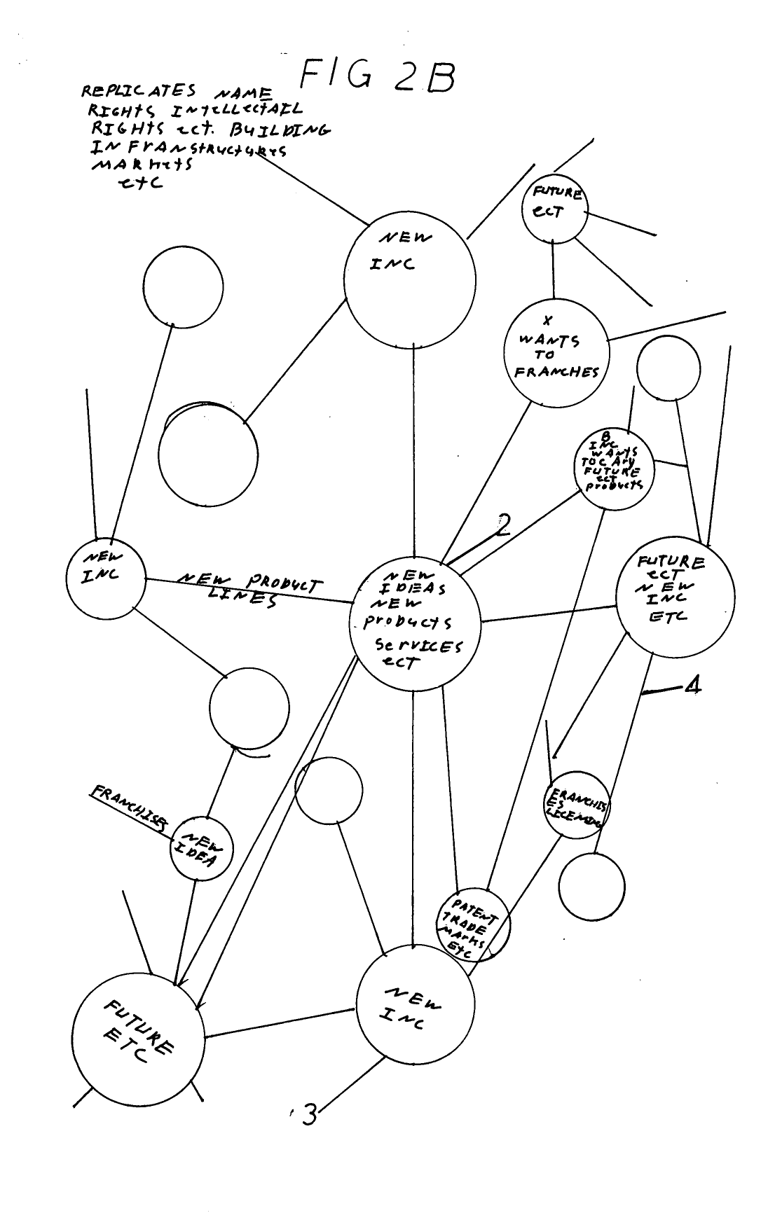

Seen in FIG. 2B

This is a view of the plan showing the replication of ideas from FUTURE creating new goods and services from people's ideas. FUTURE Cell shows the line connection to many services and the replication of FUTURE through the ideas of the people.

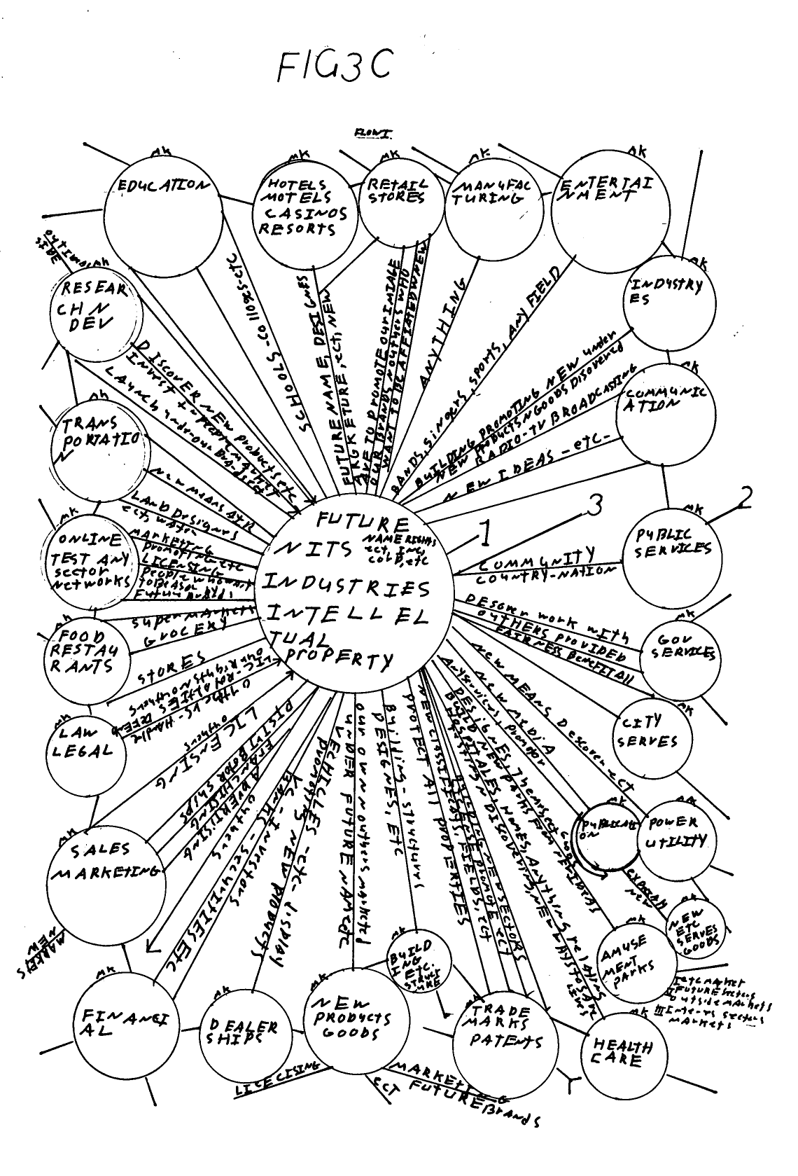

Seen in FIG. 3 C

Top view shows how FUTURE is born and how it replicates many goods and services through people and their ideas. It also shows with existing goods and services how FUTURE is born and creates new goods and services.

Illustrates further living life force and how goods and services act like and creates a world from the Brand FUTURE using people innovative ideas.

### DETAILED DESCRIPTION OF THE INVENTION

Referring to the drawings:

FIG. 1A shown FUTURE the world on line services and how they connect. No. 1 show test market in any marketing sector FUTURE world on line services, etc.

No. 2 Show FUTURE Cell. No. 3 shows services that FUTURE creates. No. 4 shows the connection and creation of and to many services and goods associated with people and their ideas for FUTURE.

FIG. 2 B show how the new ideas and new products and services replicate themselves into a new ideas and services living life force for people and their ideas for the FUTURE self supporting infrastructure. No. 2 shows new ideas, new products and services created by people and the word FUTURE, No. 3 shows new companies created by the FUTURE. No. 4 show the creation of new ideas.

FIG. 3 C shows the living enity, No. 1 of FUTURE and its industry, No 2 shows intellectual property, No. 3 show how ideas are created by and for and from people and their own ideas and the creation of using existing goods and services of others to create the heart of No. 1 showing FUTURE and its intellectual property, industries and the creation of global FUTURE.

1. is a method process creating and building vast infrastructures, methods means, distributorships, markets, structures, etc. in which to test people's ideas in any marketing sector and to market products, goods and services in any marketing sector by building infrastructures and markets around any products, goods, markets and services—anything that can be created. Included are online and online services interconnecting networks by means which sill allow the testing of peoples ideas, products and goods by and all means. Marketing and infrastructures around those products, goods and services will be built.

2. the method process of building an establishment or city, etc. which encompasses any industry and services dealing with any and all marketing sectors and of producing marketing, creating distributorships and infrastructures, etc. under the name Future, etc. brand names. Included is the process of marketing products, goods and services to others and the building of infrastructures around both said products and others, do forth, around new products and services and intellectual property discovered by the new ideas and new products. The method process will include the building of markets in infrastructures around those new ideas, products and intellectual property and so on.

3. is a process to create vast infrastructures methods where products and ideas, etc. will be tested in any marketing sector by any and all means, and where future industries interconnect so that they will remain with the main group and for investment with other companies. Future will be claiming new technology, market the products, finance the products, own channels and resources for license, market and test people's ideas in any marketing sector, and represent new ideas, new products and new intellectual property under the Future name, not limited to the Future name. Infrastructures, markets and franchises in infrastructures will build around new products, new patents, and new services and create and interconnect those markets so forth online to identify any services, goods, products and methods in which to test ideas anything in which can be thought of and created for any marketing sector.

4. the method process will include any and all infrastructures dealing with markets, distributorships sectors and any and all fields which deal with and all markets of products, goods and services especially relating to the future. The method, etc. will include any and infrastructures that will discover new products and service markets, etc. The name Future has rights in which the name also can be attached on to other names with more opportunities to launch new services, etc. under the Future names. Legal rights to patents, trademarks and intellectual properties from these properties will be secured.
Any invention or device that can be created and that can be marketed, etc. and that serves a purpose can claim the right to Future, etc. brands intellectual properties. The building of new markets for new products, services, infrastructures, networking and marketing where people will test ideas, anything that can be thought of by any and all means will be included. Any and all products and services can be tested, promoted and marketed in any marketing sector with online and interconnecting networks by any and all means set forth with the usage of the name Future and marketing under licensing of intellectual property.

5. is the process method to build a new world brand name Future and not limited to the name Future will provide the opportunity to build new markets, products and services around newly discovered properties and so forth through the interconnecting of networks and the building of new markets, new infrastructures, distributorships and the obtaining of trademark patent rights and intellectual rights around those newly discovered properties. Included is the connecting of those networks for products and services, franchising, licensing and distributing and the building of channels around those new discovered properties and the building of a Futuristic city or establishment, where all services, products and goods will be identified. The city will encompass infrastructures for the retail sector, financial sector, museum sector, educational sector, health care sector, online sector, utility sector, hotels and motels, resorts sector, industrial sector, search sector, entertainment sector, and every industry that markets any and all special services, goods and products.
The city will be the place to meet business leaders who would look at people's dreams and their abilities. This company will have the ability of marketing their products in any marketing sector and on-line worldwide. Future deals with creating its own unique society that can be protected and can serve the world in the future with the benefit to protect the knowledge of thinking positive with no prejudice and to stand as one for our world. By marketing and producing products and the distributing of the new products and ideas includes the building of vast infrastructures and markets to test people's ideas in any marketing sector by any and all means to focus on the people's ideas and dreams. Any infrastructure will be built with these entities by using the process method for interconnecting building, so forth.

6. process method is a Futuristic city, etc. on an island or elsewhere where the theme is Futuristic to be a place to test ideas for products and services in any and all marketing sectors, to provide franchise licensing by any means, and to market to other entities. Opportunity will be available to work together to discover new services in healing techniques to save lives by securing the intellectual and copyrights, etc. to new products and services, to franchise those rights and to distribute new products and services.
This entity or corporation will capture a unique market in which people will want to do business and to be identified with Future. Dealership for selling future leader automobiles, museums, libraries, retail stores, and other commerce media will be components of the market. New sports ideas and new entertainment to launch and promote dance, artist, etc. under the Future brands will be possible. Products and services, etc. will have research centers. Utility companies and financial services will be available. Business will be based on positive leadership values that are honorable. Focus is in building huge infrastructures with interconnecting networks by any and all means in which to test ideas and by any and all means online such as to read stories live anywhere in the world which connects readers in any and all languages when called upon by clients. Also online will have interconnecting networks with any and all fields, classes, etc. which tests people's ideas on-line and in the retail industry in any and all sectors, there of.

7. process method is to promote in marketing Future brands and intellectual property Future brands in any and all marketing sectors This includes products, goods and services, etc. Intent is to develop, build, and promote market distributorships, to build new market infrastructures and to build these new markets with specialty identification of the brands name and intellectual property with Future and not limited to the brand Future. Any methods, ways and means in which to build structures, test and market ideas and products, etc. In any marketing sector will be used. Any ways or means to discover new products and develop intellectual property and to build new markets around those new goods, products, services and intellectual properties will be used, as well as, to identify and make new classes to identify those services with special focusing on intellectual property rights to identify those services with special focusing on intellectual property rights in protecting and promoting those new services and goods under the Future brands. An open policy will be used to look for new ideas, to create new entities and to create infrastructures which would include on-line means in which to market, to distribute and to create new ways for people's ideas etc. or anything which is created by the thought process to be tested, produced and marketed in any marketing sector. By electronic means the building of marketing sectors and infrastructure for promoting new products, as well as, testing and evaluation of products and services can be done. Ideas, new licenses, franchises, distributorships and businesses in any marketing sector for any and all goods and services that can be identified as a service or good or product can be promoted and marketed to create a new company or companies on-line with interconnecting infrastructures in any and all industries by any and all means not limited to just online. By licensing the name Future and other entities, infrastructures will be established to test and to market ideas in any marketing sector, so forth.

8. process method is the creation and building of connecting infrastructure markets on-line with web sites, etc. to allow testing, advertisement, marketing by any and all means in any and all marketing sectors and industries of the world. New ideas can be incorporated with other ideas for the creation of new products and services. Usage rights to a name brand and ideas could include every classification of services such as retail store, industrial, entertainment, education, radio/TV broadcasting, hotel, and any and all of services of now and of the future. Any name identified with products and services online establishes usage and legal rights and then classified as intellectual property licensing, so forth.

9. process method is to invent or create and promote for manufacturers to manufacture and market licensed products under the Future name or names with intellectual property rights and to invent or discover new classes to license the Future rights. Interconnected infrastructures dealing with any marketing sector will be built. New markets for products and any services will be online interconnecting networks using web sites where any and all thought process can be tested, marketed and promoted by any and all means in any and all fields. Interconnecting markets, so forth, and the method ways and means in which doing business including discovering, testing, promoting and marketing new products will be built around those new products, goods and services and intellectual property rights. Infrastructure on online, in the retail sectors, in industrial sectors and in anything which can be identified as service for goods or products can be protected and can be identified by name or trademark or patents. Protected are methods and any and all which can be claimed, any and all means of doing business, building interconnecting industries, markets for products and goods, so forth.

10. process method is name and not limited to the name Future and claiming the process and the methods of building markets, interconnecting markets, infrastructure and anything online which will make it possible to test, promote, and market people's ideas in any marketing sector. I claim any and all ways of doing business in an interconnecting infrastructure and of building new networks and products and goods with new patents and intellectual property rights of discovered ideas and products which are to be identified by and not limited to the name Future.

11. process method creating marketing in retail store sectors, financial sectors, entertainment sectors, research sector, regular TV broadcasting sector, online sector, health care sector, and any service in any industry identified as such to be interconnected by any and all means.

12. process method to discover new technology news service as a new way of doing business with new products and new intellectual property rights, etc. With the claimed rights and rights claimed from other products, new industries and so on will be built around the newly discovered products and intellectual properties. On-line interconnecting networks will be a means to market, to promote and to license intellectual property by any and all means. People's ideas, products and marketing will be tested and used by any and all means electronically and in any and all services of now and in the future.

13. process method to create infrastructures for the discovery of new technology and patents, etc. In building infrastructures, markets, and distributorships from those intellectual properties, identification will be make with the name Future and not limited to the name Future. Interconnecting of networks and testing, promoting and marketing will make new identification of classes and define new product patents. The building of new markets and infrastructures in any sector around those newly discovered markets and patents in the retail world is not limited to just online but to the interconnection in building networks markets by any and all means.

14. method process claim the method of doing business of building and connecting infrastructures. With the building of infrastructures and interconnecting infrastructures, the building methods of structures and arena distributorships will interconnect and represent any marketing sector with any product or good and service which can be thought of. Infrastructures and interconnecting infrastructures will be used as a means to test, promote and market, etc. people's ideas or anything by any and all means, to build new products and services and to protect new intellectual property rights, etc. that can be identified and related to the future and not limited to the future. Claimed are the means and methods of interconnecting industries for testing, developing and marketing new ideas to discover new products and services, thereof.

15. process method to build structure, cities and entities that encompasses utilities and designs, etc. which are futuristic and future related which will be identified by the name of Future, etc. with protection of all intellectual property rights that can be protected and identified with the future. Interconnecting infrastructure by any and all means will allow testing, development and marketing of ideas in any and all marketing sectors with the name Future, etc. thus, discovering new intellectual properties from those entities and developing infrastructures for marketing, thereof.
